(19) United States
(12) Patent Application Publication
(10) Pub. No.: US 2006/0209020 A1
(43) Pub. Date: Sep. 21, 2006

(54) Mobile phone with a virtual keyboard

(75) Inventor: Anke Scheiblhuber, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/227,115

(22) Filed: Sep. 16, 2005

(30) Foreign Application Priority Data
Mar. 18, 2005 (TW) 94108500

(51) Int. Cl. G09G 5/00

(52) U.S. Cl. 345/156; 715/864

(57) ABSTRACT

The present invention relates to a mobile phone with a virtual keyboard. The mobile phone includes a main phone module, a rotary base, a display module, and a virtual keyboard module. The rotary base is coupled to the main phone module and is rotatable thereon. The display module is coupled to the rotary base and can be rotated by the rotary base. The display module is used for displaying the messages from the main phone module. The virtual keyboard module is located on the display module and projects the virtual keyboards.

### RELATED APPLICATIONS

The present application is based on, and claims priority from, Taiwan Application Serial Number 94108500, filed Mar. 18, 2005, the disclosure of which is hereby incorporated by reference herein in its entirety.

### BACKGROUND

1. Field of Invention

The present invention relates to a mobile phone. More particularly, the present invention relates to a mobile phone with a virtual keyboard.

2. Description of Related Art

With the development of the mobile phone technology, current mobile phone is equipped with various functions, such as internet browsing, sending emails, camera, or games. As the functions of the mobile phone expand, the input interface becomes a critical issue. For example, the volume of the current mobile phone tends to be minimized, and therefore the input interface is limited to number keyboards only or even several function keys. While the user intends to enter the alphabets, the only available approach is to enter via those number keyboards. Usually, one particular number key will represent several alphabets, and the user has to select the desired between those alphabets, which is an inefficient and time-consuming process. Moreover, the current mobile phone also provides with game options. The keyboard configuration required for the game playing is usually different from that of the conventional mobile phone. However, the user will also be restricted to the current available number keyboards while playing the game on the mobile phone, which significantly discourages the user from playing.

Therefore, there is a need for an improved mobile phone input interface that the user can input more conveniently. Besides, there is also a need for an improved input interface that facilitates the minimization of the mobile phone.

### SUMMARY

It is therefore an objective of the present invention to provide a mobile phone with a virtual keyboard for providing a more convenient input interface.

It is another objective of the present invention to provide a mobile phone that can project the virtual keyboard on a surface outside the mobile phone.

In accordance with the foregoing and other objectives of the present invention, a mobile phone with a virtual keyboard is provided. An exemplary embodiment of the mobile phone includes a main phone module, a display module, and a virtual keyboard module. The display module is electrically connected to the main phone module for displaying the messages from the main phone module. The virtual keyboard module is located on the display module for projecting the virtual keyboards.

In accordance with another objective of the present invention, a mobile phone with a virtual keyboard is provided. Another exemplary embodiment of the mobile phone includes a main phone module, a rotary base, a display module, and a virtual keyboard module. The rotary base is coupled to the main phone module and rotates thereon. The display module is coupled to the rotary base and rotated by the rotary base. The display module is electrically connected to the main phone module for displaying the messages from the main phone module. The virtual keyboard module is located on the display module and projects the virtual keyboards.

The mobile phone according to the present invention provides a virtual keyboard input interface that the physical keyboard is no longer required. The user will not be limited to the available physical keyboard and can have various types of input keyboard. Moreover, the user can customize personal virtual keyboard to facilitate the input procedures.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings, where:

FIG. 1A to FIG. 1D are perspective diagrams illustrating the mobile phone according to one preferred embodiment of the present invention; and

FIG. 2 is a perspective diagram illustrating the mobile phone according to another preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The mobile phone according to the present invention is equipped with a virtual keyboard that the space for the conventional physical keyboard is no longer required. The mobile phone can therefore be further minimized. Besides, the user will not be limited to the available physical keyboards and can have various types of input interface. Moreover, the user can also customize personal virtual keyboard to facilitate the input process.

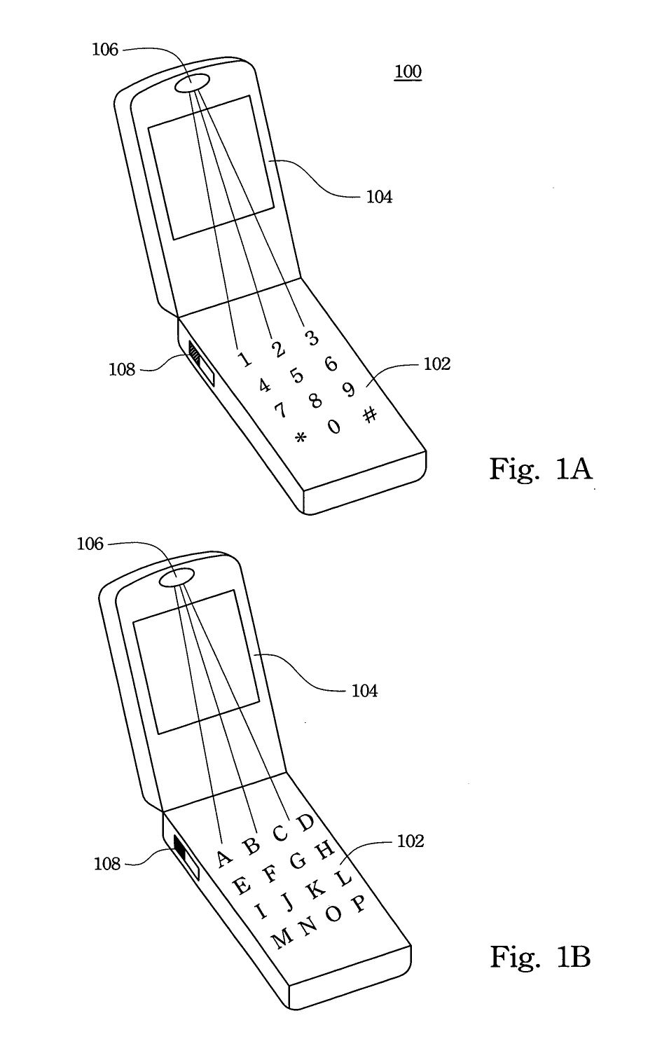

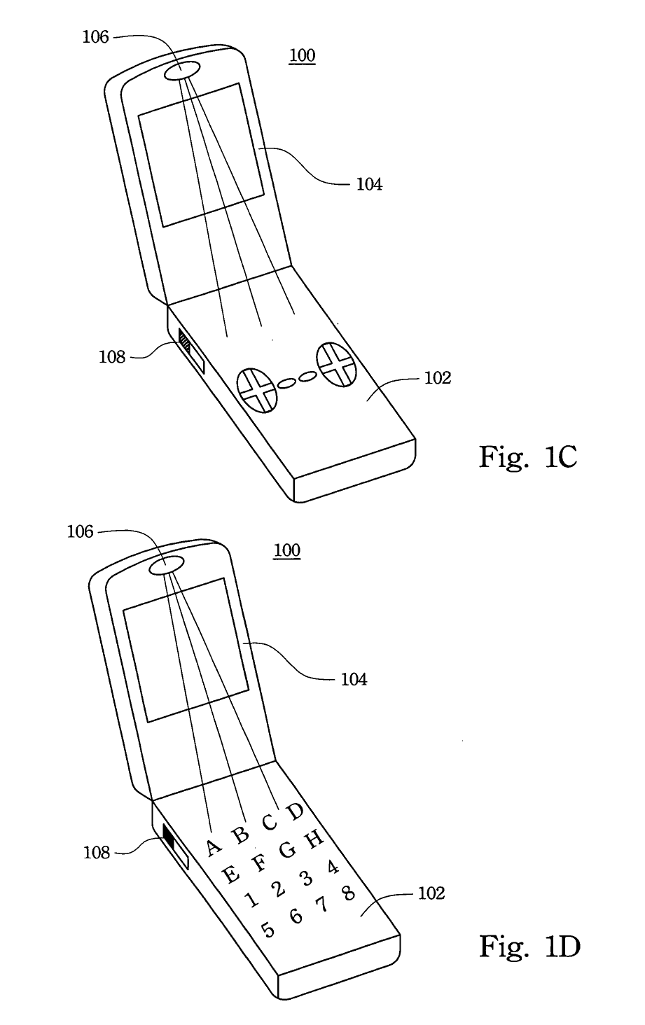

FIG. 1A is a perspective diagram illustrating the mobile phone according to one preferred embodiment of the present invention. The mobile phone 100 includes a main phone module 102, a display module 104, a virtual keyboard module 106, and a switch module 108. The main phone module 102 contains the circuitry for the mobile phone operation. The display module 104 is coupled to the main phone module 102 and is used for displaying the messages from the main phone module 102. The display module 104, for example, is a LCD screen. The virtual keyboard module 106 is located on the display module 104 and projects a virtual keyboard on the main phone module 102. As shown in the FIG. 1A, while the user needs to enter the numbers, such as during dialing, the virtual keyboard 106 projects a virtual number keyboard on the main phone module 102. The user can therefore input the number by the virtual number keyboard.

The virtual keyboard module 106, for example, can employ a LED (Light Emitting Diode) as a light source for projecting the virtual keyboard. Meanwhile, the position of the user's fingers can be tracked by an IR sensor or other alternatives.

Exception for entering the numbers, the user frequently needs to enter the alphabets while establishing the phone book. As shown in the FIG. 1B, the virtual keyboard module 106 can be switched for projecting the alphabetical virtual keyboard by the switch module 108, such as a physical switch, on the main phone module 102. Therefore, unlike the conventional mobile phone which the user has to spend enormous efforts selecting the desired alphabets, by the virtual keyboard, the user can have a handier input interface.

Moreover, the user may play the games on the mobile phone. For the conventional mobile phone, it is impossible to have keyboard configuration specifically designed for game purpose. However, as shown in the FIG. 1C, the mobile phone according to the present invention can provide the keyboard configuration specific for the game purpose. The virtual keyboard module 106 can project the virtual keyboard configuration for the game purpose by switching the switch module 108.

Furthermore, the user can customize the virtual keyboard module 106 for projecting the personal virtual keyboard. As shown in the FIG. 1D, for example, the user can customize the virtual keyboard module 106 for projecting both the number and the alphabetical keyboards at the same time. Alternatively, the user can customize the virtual keyboard module 106 for projecting the frequently-used strings that can further facilitate the input procedures.

The switch module 108 can be a physical switch. Besides, the switch module 108 can also be a touch switch incorporated into the display module 104. For example, the display module 104 can be a touch screen that the user can switch between different modes by touching the display module 104.

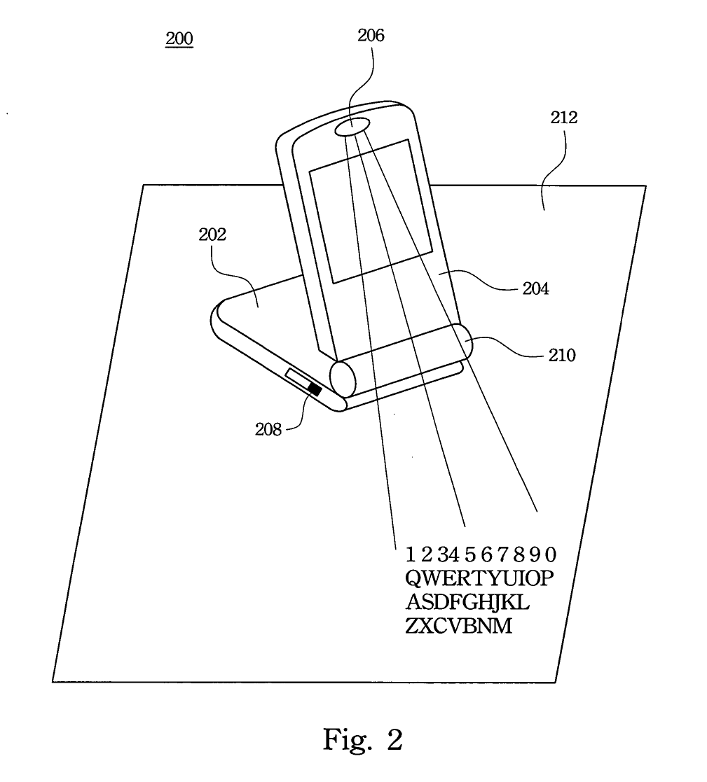

Except for projecting the virtual keyboard on the main phone module, the virtual keyboard can also be projected on other available surface. FIG. 2 is a perspective diagram illustrating the mobile phone according another preferred embodiment of the present invention. The mobile phone 200 includes a main phone module 202, a display module 204, a virtual keyboard module 206, a switch module 208, and a rotary base 210. The main phone module 202 contains the circuitry for the mobile phone operation. The rotary base 210 is coupled to the main phone module 202 and is rotatable on the main phone module 202. The display module 204 is coupled to the rotary base 210 and is used for displaying the messages from the main phone module 202. For example, the display module 204 can be a LCD screen. The display module 204 can be rotated on the main phone module 202 by the rotary base 210. Therefore, by rotating the rotary base 210, the virtual keyboard module 206 can project the virtual keyboard on a surface other than the main phone module 202. For example, while the mobile phone 200 is placed on a table 212, the display module 204 can be rotated 180 degree that the virtual keyboard module 206 projects the virtual keyboard on the table 212. In this way, the size of the virtual keyboard can be expanded and will not be restricted to the main phone module 202.

The mobile phone according to the present invention provides a virtual keyboard input interface that the physical keyboard is no longer required. The user will not be limited to the available physical keyboard and can have various types of input keyboard. Moreover, the user can customize personal virtual keyboard to facilitate the input procedures. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A mobile phone with a virtual keyboard, the mobile phone comprising:
a main phone module;
a display module electrically connected to the main phone module for displaying messages from the main phone module;
a virtual keyboard module located on the display module for projecting virtual keyboards; and
a switch module for switching between the virtual keyboards.

2. The mobile phone of claim 1, wherein the virtual keyboards are customized.

3. The mobile phone of claim 1, wherein the switch module is a physical switch.

4. The mobile phone of claim 1, wherein the switch module is located on the main phone module.

5. The mobile phone of claim 1, wherein the switch module is a touch switch.

6. The mobile phone of claim 5, wherein the touch switch is incorporated into the display module.

7. The mobile phone of claim 1, wherein the virtual keyboard module projects the virtual keyboards on the main phone module.

8. A mobile phone with a virtual keyboard, the mobile phone comprising:
a main phone module;
a rotary base coupled to the main phone module and is rotatable on the main phone module;
a display module coupled to the rotary base and rotated by the rotary base, and the display module electrically connected to the main phone module for displaying messages from the main phone module; and
a virtual keyboard module located on the display module for projecting virtual keyboards; and
a switch module for switching between the virtual keyboards.

9. The mobile phone of claim 8, wherein the virtual keyboards are customized.

10. The mobile phone of claim 8, wherein the switch module is a physical switch.

11. The mobile phone of claim 8, wherein the switch module is located on the main phone module.

12. The mobile phone of claim 8, wherein the switch module is a touch switch.

13. The mobile phone of claim 12, wherein the touch switch is incorporated into the display switch.

14. The mobile phone of claim 8, wherein the virtual keyboard module projects the virtual keyboards on the main phone module.

15. The mobile phone of claim 8, wherein the virtual keyboard module projects the virtual keyboards on a surface other than the main phone module.
